(19) United States
(12) Patent Application Publication
(10) Pub. No.: US 2026/0093593 A1
(43) Pub. Date: Apr. 2, 2026

(54) System for Automatically Evaluating the Output of Machine-Learned Models

(71) Applicant: Google LLC, Mountain View, CA (US)

(72) Inventors: Noam Velan, Hod Hashron (IL); Doron Kukliansky, Ra'anana (IL); Alexander Goldshtein, Tel Aviv (IL); Yehonatan Bitton, Givatayim (IL); Itay Laish, Timrat (IL); Idan Szpektor, Kfar Saba (IL); Ofir Roval, Tel Aviv (IL)

(21) Appl. No.: 19/342,072

(22) Filed: Sep. 26, 2025

Related U.S. Application Data
(60) Provisional application No. 63/702,013, filed on Oct. 1, 2024.

(51) Int. Cl. G06F 11/34; G06F 16/3329

(52) U.S. Cl. CPC G06F 11/3414; G06F 16/33295

(57) ABSTRACT

Provided is a system that automatically evaluates the output of machine-learned models. A computing system receives, from a user computing device, an input query. The computing system processes the input query with a generative model to generate a model output based on the input query. The computing system identifies one or more representative subsequences that correspond to a representation based on the textual response. The computing system generates a plurality of tuple pairs based on the one or more representative subsequences that correspond to a representation and the one or more media elements. For each of the relevant tuple pairs, the computing system processes the respective tuple pair with an entailment-scoring machine-learned model to generate an entailment score for the respective tuple pair. The computing system provides an entailment output for the model output based on the respective entailment scores generated for the one or more relevant tuple pairs.

### PRIORITY CLAIM

The present application claims priority to U.S. Provisional Application No. 63/702,013 filed Oct. 1, 2024 which is hereby incorporated by reference herein in its entirety.

### FIELD

The present disclosure relates generally to machine-learned models. More particularly, the present disclosure relates to a system that can enable a user to automatically evaluate the output of a generative model.

### BACKGROUND

The capability of large language machine-learned models to generate content in response to a prompt has greatly increased. However, even well-trained machine-learned models can generate output that includes inaccurate information or is not responsive to a prompt. As a result, it is important when training a model to evaluate the output of the machine-learned models. However, it can be computationally expensive and/or time-consuming to evaluate the output of a machine-learned model.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can be performed by a computing system comprising one or more processors. The one or more operations comprise receiving, by a computing system with one or more processors, an input query. The operations further comprise processing, by the computing system, the input query with a generative model to generate a model output based on the input query, wherein the model output comprises a textual response, and wherein one or both of the input query and the output comprise one or more media elements. The operations further comprise identifying, by the computing system, one or more representative subsequences that correspond to a representation based on the textual response. The operations further comprise generating, by the computing system, a plurality of tuple pairs based on the one or more representative subsequences that correspond to a representation and the one or more media elements. The operations further comprise for each of one or more relevant tuple pairs in the plurality of tuple pairs, processing, by the computing system, the respective tuple pair with an entailment-scoring machine-learned model to generate an entailment score for the respective tuple pair. The operations further comprise providing, by the computing system, an entailment output for the model output based on the respective entailment scores generated for the one or more relevant tuple pairs.

Another example aspect of the present disclosure is directed to a computing system for automatically evaluating a model output. The system can include one or more processors and one or more non-transitory computer-readable media that collectively store instructions that, when executed by the one or more processors, cause the computing system to perform operations. The operations can include receiving an input query. The operations can include processing the input query with a generative model to generate a model output based on the input query, wherein the input query comprises textual content, and wherein one or both of the input query and the output comprise one or more media elements. The operations can include identifying one or more requests based on the input query. The operations can include generating a plurality of tuple pairs based on the one or more representative subsequences that correspond to a representation and the one or more media elements. The operations can include, for each of one or more relevant tuple pairs in the plurality of tuple pairs, processing the respective tuple pair with an entailment-scoring machine-learned model to generate an entailment score for the respective tuple pair. The operations can include providing an entailment output for the model output based on the respective entailment scores generated for the one or more relevant tuple pairs.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 represents an example of a system for evaluating machine-learned models in accordance with example embodiments of the present disclosure;

FIG. 2 represents an example system for using communication agents to cooperatively narrow a set of possible outcome values to select a final outcome value in accordance with example embodiments of the present disclosure;

FIG. 3 depicts an example flow for evaluating the output of a generative model in accordance with example embodiments of the present disclosure;

FIG. 4 depicts a block diagram of an example computing system for automatically evaluating the output of machine-learned models for quality according to example embodiments of the present disclosure;

FIG. 5 is a flow diagram representing a process for automatically evaluating the output of a generative model in accordance with example embodiments of the present disclosure;

FIG. 6 is a flow diagram representing a process for automatically evaluating the output of a generative model in accordance with example embodiments of the present disclosure;

FIG. 7A is an example input query and model output in accordance with example embodiments of the present disclosure;

FIG. 7B is an example input query and model output in accordance with example embodiments of the present disclosure;

FIG. 8 is a block diagram of an example processing flow for using machine-learned model(s) 1 to process input(s) 2 to generate output(s) 3;

FIG. 9 is a block diagram of an example implementation of an example machine-learned model configured to process sequences of information;

FIG. 10 is a block diagram of an example technique for populating an example input sequence 8;

FIG. 11 is a block diagram of an example computing device 98 that performs according to example embodiments of the present disclosure; and

FIG. 12 is a block diagram of an example computing device 99 that performs according to example embodiments of the present disclosure.

Reference numerals that are repeated across plural figures are intended to identify the same features in various implementations.

### DETAILED DESCRIPTION

Generally, the present disclosure is directed towards a system that can automatically evaluate the output of a machine-learned model to determine whether it meets one or more quality standards. To do so, a computing system can receive an input query. Based on the input query, the machine-learned model (e.g., a sequence processing model or other generative model) can take the input query as input and produce a model output. In this example, the input query and the model output of the machine-learned model can include textual content and/or one or more media elements. The media elements can comprise one or more of: image content, video content, audio content, and interactive content. In some examples, the input query and model output can be multimodal, including two or more different types of content.

An evaluation system can access textual content in the model output and separate it into one or more portions of text (e.g., spans). The evaluation system can provide each portion of text as input to a representation-extraction machine-learned model. The representation-extraction machine-learned model can identify one or more representative subsequences that correspond to a representation within each portion of text. In some examples, representative subsequences that correspond to a representation can be statements that can be evaluated for quality by a machine-learned model. In some examples, quality can be measured, at least in part, on the accuracy of any representations in the subsequences.

The evaluation system can store a list of all representative subsequences that correspond to a representation identified within the textual content and a list of one or more media elements included in the input query or the model output. The evaluation system can generate a plurality of tuple pairs, each tuple pair comprising one representative subsequence that corresponds to a representation and one media element. The total number of generated tuple pairs can equal the number of representative subsequences that correspond to a representation multiplied by the number of media elements. In some examples, the evaluation system can provide each tuple pair as input to a relevance-determination machine-learned model. The relevance-determination machine-learned model can output a relevance score for each respective tuple pair. The relevance score can represent the degree to which the representative subsequence that corresponds to a representation included in the tuple pair is relevant to the media element in the tuple pair. For example, if the representative subsequence that corresponds to a representation is about (or otherwise relevant to) the contents of the media element, the generated relevance score will be higher than if the representative subsequence that corresponds to a representation is directed toward a different topic.

For each tuple pair, the evaluation system can determine whether its associated relevance score satisfies a threshold relevance score. The evaluation system can generate a list of tuple pairs that have a relevance score that satisfies (e.g., exceeds) the threshold relevance score and are thus determined to be relevant. The evaluation system can provide each relevant tuple pair as input to entailment-scoring machine-learned model. An example of a entailment-scoring machine-learned model can be a visual natural language inference model (VNLI model). Other machine-learned models can be used. The VNLI model can generate an entailment score for each relevant tuple pair. The entailment score can represent the degree to which the representative subsequence that corresponds to a representation in the tuple pair has good quality with respect to the media element in the tuple pair. The evaluation system can compare the entailment score for each tuple pair to a threshold quality score. If the entailment score for a respective tuple pair exceeds the threshold quality score, the evaluation system can determine that the representative subsequence that corresponds to a representation in the respective tuple pair has high quality with respect to the media element in the respective tuple pair.

In some examples, if any relevant tuple pairs are determined to include a low quality (e.g., inaccurate) representative subsequence that corresponds to a representation, the evaluation system can generate an entailment output indicating that the model output does not meet quality standards. The entailment output can be used to provide feedback to, train, or otherwise improve the generative model.

For example, the input query may include an image and a request stating, “Does this image include a rider on a horse?” The generative model can generate a model output in response to this input query. In this example, the generated output states, “Yes, this image includes a rider on a horse.” The evaluation system can determine one or more representative subsequences that correspond to a representation in the textual content included in the model output. For example, the identified representative subsequences that correspond to a representation can include “the image includes a rider,” “the image includes a horse,” and “the rider in the image is on the horse in the image.” Each representative subsequence that corresponds to a representation can be paired with the image in three different tuple pairs. Each tuple pair can be deemed to include a representative subsequence that corresponds to a representation that is relevant to the image. Each relevant representative subsequence that corresponds to a representation can be provided to a VNLI model. Depending on the input image, the VNLI can determine whether each representative subsequence that corresponds to a representation has high quality. For example, if all representative subsequences that correspond to a representation are determined to have high quality, the entailment output is determined to meet quality control standards. If one of the relevant representative subsequences that correspond to a representation is determined to have low quality (e.g., with regards to accuracy or another measure of quality), the evaluation system can determine that the model output fails to meet quality standards.

More particularly, machine-learned models can generate an output based on input. When training such models, it is important to quickly and efficiently evaluate the output provided by the models to determine whether it meets quality standards. However, effectively evaluating the model output can be expensive and time-consuming. Thus, the present disclosure discusses a method for enabling more effective review and evaluation of the output provided by a generative model.

To do so, a computing system can receive an input query. The input query can include textual content, one or more media elements, or both. In some examples, the input query can be multimodal (e.g., it can include two or more types of content). In some examples, the computing system can use the information in the input query to generate a prompt (e.g., an input to a machine-learned model that uses natural language to describe a request) that can be provided to a generative model (e.g., a sequence processing model) as input. The generative model can generate a model output based on the prompt. In some examples, the model output can be multimodal. A multimodal output can be an output that has more than one type of output (e.g., more than one type of content). In this context, media elements can refer to image content, video content, audio content, or interactive content. For example, the input query can include a specific request for media content to be produced. In other examples, the generative model is trained to produce media content as part of the output provided to a user.

In some examples, the input query can be about one or more media elements the user has provided as part of the input query. For example, the user can submit an image and provide a request that states, “Does this image include a giraffe?” The generative model can produce an output that includes a textual response to the query. For example, the textual response is, “Yes, this image includes two giraffes.” In some examples, the output can also include an image in which the two giraffes are highlighted to make them more noticeable to the user.

Once the model output has been received, the evaluation system can determine whether the model output meets one or more quality standards. These quality standards can include determining that any assertions made in the textual response are accurate based on available web data and with respect to any media content elements that have been received or produced. In this example, the evaluation system can determine whether the model output is accurate based on information available from web sources and that the representative subsequence that corresponds to a representations in the textual response accurately reflects the contents of any received or generated media elements.

To do so, the evaluation system can use a machine-learned model to analyze the textual portion of the output. In some examples, the evaluation system can divide the textual response into one or more portions of text (e.g., spans). Each portion of text can include a group of words up to the length of a sentence. Each portion of text can be analyzed by a representation-extraction machine-learned model (e.g., a machine-learned model) to determine whether the span includes any representative subsequences that correspond to a representation. Representative subsequences that correspond to a representation can be evaluated for quality (e.g., based on the degree to which the representative sequences are accurate). In some examples, a machine-learned model can be trained to take portions of text as input and to output one or more representative subsequences that correspond to a representation included in those portions of text.

For example, if the portion of text reads “the image shows a boy and a horse,” the representation-extraction machine-learned model can output two representative subsequences that correspond to a representation. The first representative subsequence that corresponds to a representation may be “there is a boy in the image” and the second representative subsequence that corresponds to a representation may be “there was a horse in the image.” This process can be repeated with each portion of text in the textual content.

Once the evaluation system has generated a list of all representative subsequences that correspond to a representation made by the textual portion of the model output, the evaluation model can create a series of tuple pairs. Each tuple pair can include one representative subsequence that corresponds to a representation and one media element. In some examples, the total number of tuple pairs created equals the number of representative subsequences that correspond to a representation (C) multiplied by the number of media elements (E). Thus, the total number of tuple pairs equals C*E, so each representative subsequence that corresponds to a representation is paired with each media element in one tuple pair.

The evaluation system can use a trained relevance-determination machine-learned model to determine, for each tuple pair, whether the representative subsequence that corresponds to a representation in the tuple pair is relevant to the media element in the tuple pair. For example, if multiple media elements are produced, each representative subsequence that corresponds to a representation may be relevant to only one of those tuple pairs. The relevance-determination machine-learned model can identify which representative subsequences that correspond to a representation are relevant to which media elements. In some examples, a particular representative subsequence that corresponds to a representation may be relevant to all the media elements. For example, if a received input query includes three images, the model output can include the representative subsequence that corresponds to a representation “all three images include trains.” In this example, the relevance-determination machine-learned model can determine that the representative subsequence that corresponds to a representation is relevant to each image. In some examples, the relevance-determination machine-learned model used to produce this determination is a multimodal required attribution detector (MM-RAD).

The relevance-determination machine-learned model (e.g., the MM-RAD) can take each tuple pair in the list of tuple pairs as input and generate a relevant score for that tuple pair. The relevance score can represent the degree to which the representative subsequence in the tuple pair is relevant to the media element in the tuple pair. Each tuple pair can have an associated relevance score. Note that the relevance-determination machine-learned model is not checking for accuracy or truthfulness in the representative subsequence that corresponds to a representation itself. Thus, a representative subsequence that corresponds to a representation about an image may later turn out to not be accurate but may still be relevant. For example, if the representative subsequence that corresponds to a representation is “there is a red cat in this image,” but the image actually contains a black cat, the representative subsequence that corresponds to a representation will still be deemed relevant because it is a representative subsequence that corresponds to a representation about the contents of the image.

In some examples, the evaluation system can determine a list of tuple pairs with an associated relevance score that exceeds a threshold relevance score. In some examples, the threshold relevance score is predetermined. The evaluation system can access the list of relevant tuple pairs and provide each respective relevant tuple pair to an entailment-scoring machine-learned model. The entailment scoring machine-learned model can be a VNLI model. The entailment scoring machine-learned model can be trained to generate an entailment score for each relevant tuple pair. The entailment score can represent the degree to which the representative subsequence that corresponds to a representation in the tuple pair has high quality (e.g., is accurate) with respect to the media element in the tuple pair. In some examples, the entailment score for each tuple pair can be compared to a predetermined threshold entailment score. The predetermined threshold entailment score can be a value above which the evaluation system can determine that a representative subsequence that corresponds to a representation has high quality (e.g., with respect to accuracy) and below which the evaluation system can determine that a representative subsequence that corresponds to a representation has low quality.

In some examples, if all of the representative subsequences that correspond to a representation in the list of relevant representative subsequences that correspond to a representation (e.g., based on the list of relevant tuple pairs) are determined to have high quality (e.g., with an entailment score above the predetermined threshold entailment score), the evaluation system can determine that the model output meets one or more quality requirements with respect to the one or more media elements.

In addition to determining whether one or more representative subsequences that correspond to a representations have high quality with respect to the media elements, the evaluation system can determine whether a representative subsequence that correspond to a representation has high quality (e.g., is accurate or other measures of quality) with respect to data available via a web search. The evaluation system can provide each identified representative subsequence that corresponds to a representation (e.g., extracted from the textual content of the model output as described above) to a relevance-determination machine-learned model. In this example, the relevance-determination machine-learned model can be a web-attribution required attribution detector model. The web-attribution required attribution detector model can generate a web relevance score for each representative subsequence that corresponds to a representation. The web relevance score can represent the degree to which the representative subsequence that corresponds to a representation can be validated based on information available using a web search or through other information accessible on the Internet through communication networks. Once each representative subsequence that corresponds to a representation has received a web relevance score, the evaluation system can determine a list of web-relevant representative subsequences that correspond to a representation. The list of web-relevant representative subsequences that correspond to a representation can be determined based on whether the web relevance score for each representative subsequence that corresponds to a representation exceeds (or otherwise satisfies) a predetermined threshold web relevance score.

Once the list of web relevant representative subsequences that correspond to a representation is determined, the evaluation system can provide each web relevant representative subsequence that corresponds to a representation to an entailment-scoring machine-learned model that has access to web information and can be used to generate an entailment score for those representative subsequences that correspond to a representation. For example, the entailment-scoring machine-learned model can be a natural language inference model that has web retrieval.

The evaluation system can generate entailment output for the model output. The entailment output can include the entailment scores for the relevant representative subsequences that correspond to a representation determined by the relevance-determination machine-learned model (e.g., a MM-RAD model or the web attribution required attribute detector model). Each relevant representative subsequence that corresponds to a representation can have one or more entailment scores (e.g., if the representative subsequence that corresponds to a representation is determined to be relevant to a media element, relevant for web-based evaluation, or both). The evaluation system can determine whether the entailment score(s) associated with each relevant representative subsequence that corresponds to a representation exceeds a threshold entailment score. In some examples, if all the relevant representative subsequences that correspond to a representation have associated entailment scores that satisfy the threshold entailment score, the entailment output can indicate that the model output meets a quality measure for generated output (e.g., or other quality standards).

If one or more representative subsequences that correspond to a representation do not meet the predetermined threshold entailment score, the evaluation system can generate an entailment output that indicates the model output fails to meet quality standards. In some examples, if the model output fails to meet quality standards, the entailment output can be used to train or otherwise improve the generative model. The generative model (e.g., sequential processing model) can be updated based on the information in the entailment output, including the one or more specific representative subsequences that correspond to a representation determined to have low quality (e.g., with respect to accuracy or other measures of quality).

The evaluation system can also be provided to screen model output generated for users. For example, if a particular model output is generated in response to an input query, the evaluation system can evaluate the model output for quality as described above. If at least one representative subsequence that corresponds to a representation is determined to have low quality (e.g., with respect to the evaluation system can provide an updated prompt to the generative model requesting that new output be generated and noting the error in the previous output. In this way, errors in output can be corrected in real time before being displayed to users.

In some examples, the evaluation system can also determine whether the output aligns with the input query (or a prompt generated based on the input query). In some examples, the input query can include a textual portion. The input query can also include one or more media elements. The evaluation system can determine whether the output provided by the generative model (e.g., a sequence processing model) meets the requests present in the input query. In some examples, the evaluation system can use a request-extraction model (e.g., similar to the representation-extraction machine-learned model described above) to extract one or more requests in the textual portion of the input query. For example, the evaluation system can divide the textual portion into a series of portions of text (e.g., spans).

Each portion of text can be provided to the request extraction machine-learned model that extracts one or more requests from the span. A relevance determination machine-learned model (e.g., a multimodal required attribution detector model or a web attribution required attribution detector model) can evaluate each request to determine its relevance. In some examples, the evaluation system can create a plurality of tuple pairs. The tuple pairs can include one request and one media element from the input query or the model output. Thus, each tuple pair can be evaluated to determine whether the request is relevant to the included media element.

The relevance determination machine-learned model can generate a relevance score for each tuple pair. The evaluation system can use the relevance scores for each tuple pair to generate a list of relevant tuple pairs. An entailment-scoring machine-learned model (e.g., a VNLI model) can generate an entailment score for each tuple pair. The entailment score can represent the degree to which the media element meets the request. For example, if the request includes the text “please create an image of a brown cat,” the entailment score can be determined based on whether an image generated by the generative model includes a visual representation of a brown cat.

The evaluation system can determine whether each request has an entailment score above a threshold entailment score. The entailment score can represent the degree to which the model output meets the request in the input query. In some examples, if all of the requests have an entailment score above the predetermined threshold entailment score, the evaluation system can determine that the model output meets the quality standards of the generative model. If at least one of the requests does not meet the threshold entailment score, the evaluation system can determine that the model output does not meet the quality requirements and can provide feedback to the generative model for training the model.

The systems and methods of the present disclosure provide a number of technical effects and benefits. As one example, the systems and methods can provide an automatic evaluation of model output for quality. Automatically and accurately evaluating the output of a machine-learned model for quality can significantly reduce the time and cost needed to train a useful machine-learned model.

Another example of technical effect and benefit relates to improved computational efficiency and improvements in the functioning of a computing system. For example, a technical benefit of the systems and methods of the present disclosure is the ability to reduce the computational resources needed for training and/or tuning a generative model for generating high-quality outputs. In particular, the generative model can be utilized to generate responses to prompts. Automatically and accurately evaluating the output of the generative model can improve the quality of the model output of the generative model. A machine-learned model that produces model output that is more likely to be high quality can reduce power usage and processor usage of the system providing the generative model.

With reference now to the Figures, example embodiments of the present disclosure will be discussed in further detail.

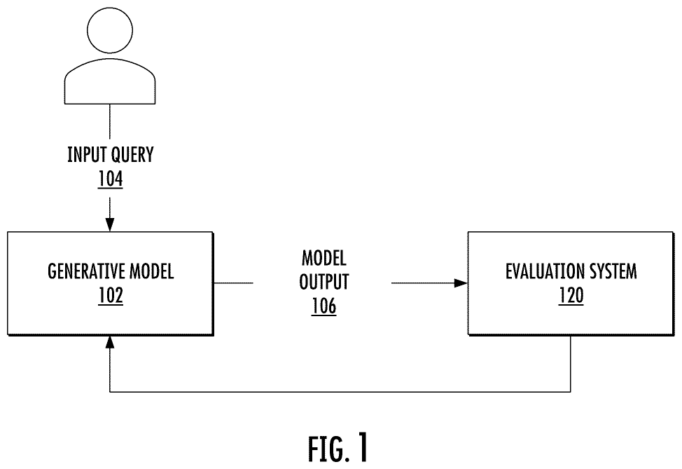

FIG. 1 represents an example of a system for evaluating the model output of machine-learned models in accordance with example embodiments of the present disclosure. In this example, the system can access an input query 104. The input query can include textual content. In some examples, the input query can also include one or more media elements. The media elements can include image content, video content, audio content, interactive content, etc. In some examples, the input query 104 can be multimodal and include two or more types of content. The input query 104 can be included in a prompt that is provided to the generative model 102 as input. The generative model 102 can be trained such that it provides a model output based on the input query 104.

The generative model 102 (e.g., a sequence processing system) can generate model output 106. In some examples, the model input can include textual content and/or one or more media elements. The model output 106 can be multimodal. The model output 106 can be received by the evaluation system 120. The evaluation system 120 can automatically determine whether the model output 106 meets one or more quality requirements for the generative model 102.

The evaluation system 120 can employ a plurality of machine-learned models to evaluate the model output. A representation extraction machine-learned model can extract representative subsequences that correspond to a representation from the textual portion of the output. A relevance-determination machine-learned model can evaluate each representative subsequence that corresponds to a representation to determine whether it is relevant with respect to a media element. An entailment-scoring machine-learned model can generate an entailment score for each relevant representative subsequence that corresponds to a representation. The evaluation system 120 can determine whether the model output 106 meets one or more quality standards based on the entailment score for each relevant representative subsequence that corresponds to a representation.

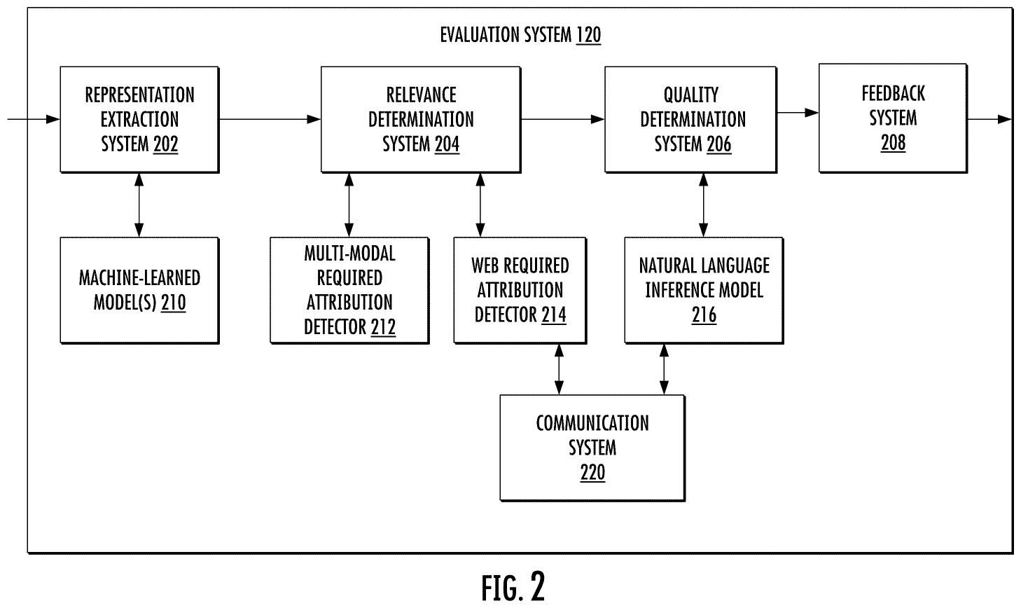

FIG. 2 depicts an evaluation system 120 in accordance with example embodiments of the present disclosure. In this example, evaluation system 120 can include multiple components. For example, the evaluation system 120 can include representation extraction system 202, a relevance determination system 204, a quality determination system 206, a feedback system 208, one or more machine-learned models 210, a multimodal required attribution detector 212, a web attribution required attribution detector 214, and natural language inference model 216, and a communication system 220. In this example, the components of the evaluation system 120 can be understood as code modules, physical system components, or representations of the processes performed by a single system (e.g., the evaluation system 120), but without specific independent components within the system as depicted.

The evaluation system 120 can be used for multiple different evaluation types. For example, the evaluation system 120 can be used to evaluate the quality of the text of the output with respect to one or more media elements (e.g., query media elements or output media elements). The evaluation system 120 can be used to evaluate the quality of the text with respect to web-based information. The evaluation system 120 can be used to determine the quality of the output (e.g., text and/or media elements) with respect to one or more requests in the input query.

In this example, a representation extraction system 202 can receive a model output from a generative model (e.g., a sequence processing model or other generative model). The model output can include textual content and/or one or more media elements. The model output can be multimodal. The media elements can include one or more of: image content, video content, audio content, interactive content, etc. The representation extraction system 202 can divide the textual content into one or more portions of text (e.g., spans). The portions of text can be a group of words as long as a sentence. The representation extraction system 202 can provide each portion of text to a machine-learned model 210. The machine-learned model 210 can be a representation extraction machine-learned model trained to identify one or more representative subsequences that correspond to a representation included in the portion of text. A representative subsequence that corresponds to a representation can be evaluated for quality. In some examples, quality can be measured based on the accuracy of the representation. For example, representations that accurately describe an image are determined to have a higher quality than representations that do not accurately describe an image.

Once the representation extraction system 202 has extracted a plurality of representative subsequences that correspond to a representation from the textual content of the model output, the list of representative subsequences that correspond to a representation can be provided to the relevance determination system 204. The representation extraction system 202 can provide the model output to the relevance determination system 204. In some examples, the relevance determination system 204 can generate a plurality of tuple pairs. A tuple pair can be a data structure that stores one representative subsequence that corresponds to a representation and one media element. The relevance determination system 204 can generate all possible combinations of representative subsequences that correspond to a representation and media elements (including media elements from the input query and the model output) such that the total number of generated tuple pairs can be equal to the number of representative subsequences that correspond to a representation multiplied by the number of media elements.

The relevance determination system 204 can provide each tuple pair in the plurality of tuple pairs to a relevance-scoring machine-learned model. The relevance-scoring machine-learned model is a multimodal required attribution detector 212. Other relevance-scoring machine-learned models can be used. The multimodal required attribution detector 212 can be trained to generate a relevance score based on a representative subsequence that corresponds to a representation included in a tuple pair and the media element included in the tuple pair. The relevance score can be a representation of the degree to which the representative subsequence that corresponds to a representation is relevant to the media element included in the tuple pair. For example, if a particular representative subsequence that corresponds to a representation describes the contents of a particular image in the one or more media elements, the relevance score for the particular image can be high. However, if the representative subsequence that corresponds to a representation is directed towards a different image than the current image in the tuple pair, the relevance score can be low.

The relevance determination system 204 can generate a relevance score for each tuple pair in the plurality of tuple pairs. The relevance determination system 204 can compare the relevance score for each tuple pair to a predetermined threshold relevance score. If a relevance score for a respective tuple pair exceeds the threshold relevance score, the relevance determination system 204 can determine that the respective tuple pair is relevant. If the relevance score does not exceed the threshold relevance score, the relevance determination system 204 can determine that the tuple pair is not relevant.

The quality determination system 206 can receive all the representative subsequences that correspond to a representation (including tuples and requirements) with a relevance score that satisfies a threshold relevance score. The quality determination system 206 can then provide each tuple in the list of relevant tuple pairs to an entailment scoring machine-learned model. The entailment-scoring machine-learned model can be a natural language inference model 216. Because the tuple pairs include both text and a media element, the entailment-scoring machine-learned model can be a visual language inference model (e.g., a VNLI model).

In some examples, the natural language inference model 216 can generate an entailment score for each tuple pair that was determined to be relevant. The entailment score can be a value that represents the degree to which the representative subsequence that corresponds to a representation in the tuple pair is determined to have high quality with respect to the media element in the tuple pair. To determine whether a particular representative subsequence that corresponds to a representation has high quality (e.g., with respect to accuracy or other measures of quality), the entailment score associated with the tuple pair can be compared to a threshold entailment score. If the entailment score is above the threshold entailment score, the representative subsequence that corresponds to a representation in the tuple pair can be determined to have high quality. If the entailment score is below the threshold entailment score, the representative subsequence that corresponds to a representation in the tuple pair can be determined to have low quality with respect to the media element in the tuple pair.

In some examples, if any relevant representative subsequence that corresponds to a representation is determined to have low quality, the quality determination system 206 can determine that the model output does not meet the quality standards for the generative model. As a result, the quality determination system 206 can provide entailment output to the feedback system 208 indicating that the outcome does not meet quality standards. The feedback system 208 can provide the entailment output to a training system to indicate that the output does not meet quality standards and provide information about the specific aspect of the model output that has low quality (e.g., the representative subsequence that corresponds to a representation or tuple pair that was determined to be inaccurate). This information can be used to alter or upgrade or further train the generative model to provide more accurate output.

If the quality determination system 206 determines that all relevant representative subsequences that correspond to a representation meet the threshold for quality, the quality determination system 206 can determine that the output does meet quality requirements. This information can be provided to the feedback system 208. The feedback system 208 can provide this feedback to a training system for improvement of the generative model.

In another example, the relevance determination system can provide the identified representative subsequences that correspond to a representation (or requirements) to a web required attribution detector 214. The web required attribution detector 214 can be a machine-learned model that is trained to determine whether a particular representative subsequence that corresponds to a representation (or requirement) can be evaluated for quality based on data available to the evaluation system (e.g., via a web search). The web-required attribution detector 214 can generate a web relevance score for each representative subsequence that corresponds to a representation. The web relevance score can indicate whether the representative subsequence that corresponds to a representation can be evaluated by information available on the web.

Each representative subsequence that corresponds to a representation with a web relevance score above a threshold web relevance score can be provided by the relevance determination system to the quality determination system 206. The quality determination system 206 can employ the natural language inference model 216 to determine an entailment score for the representative subsequence that corresponds to a representation. The natural language inference model 216 can use a communication system 220 to access data to evaluate the representative subsequence that corresponds to a representation for quality (e.g., with regards to accuracy or other measures of quality). Each representative subsequence that corresponds to a representation can receive a web entailment score. The quality determination system 206 can determine that representative subsequences that correspond to a representation with web entailment scores above a threshold web entailment score have high quality and representative subsequences that correspond to a representation with web entailment scores below the threshold web entailment score can be determined to have low quality. The feedback system can include the information about the quality of a representative subsequences that correspond to a representation with respect to web data in the entailment output.

Another use case of the evaluation system 120 can be to determine whether the model output successfully meets the requests of the input query. In some examples, the representation extraction system 202 can evaluate text associated with an input query. For example, the representation extraction system 202 can receive an input query that includes a textual portion. The textual portion can be divided into a plurality of portions of text (e.g., spans). The representation extraction system 202 can provide each portion of text to the machine-learned model 210. The machine-learned model can extract one or more requests from the input query with respect to the model output. For example, a request can be an element that is expected in the model output based on the text of the input query. For example, the input query can include a request to generate an image of a cat wearing a cowboy hat. The machine-learned models 210 may determine two requests: “an image that includes a cat” and “the cat in the image is wearing a cowboy hat.”

The requests from the input query can be matched in tuple pairs with the media elements in the output. As above, the relevance determination system can provide each tuple pair to a multimodal required attribution detector 212. The multimodal required attribution detector 212 can generate a relevance score for each request with respect to the associated media element. In this way, the relevance determination system 204 can determine, for each request, whether it is relevant to a particular media element. The relevance determination system 204 can provide each relevant tuple pair to the quality determination system 206.

The quality determination system 206 can use a VNLI model (e.g., natural language inference model 216) to generate an entailment score for each tuple pair. The quality determination system 206 can determine that tuple pairs with entailment scores above a threshold entailment score are associated with requests that are successfully met by the output and tuple pairs with entailment scores below the threshold entailment score are associated with requests that are not successfully met by the model output.

The feedback system 208 can provide information about the degree to which each request is satisfied in the entailment output. The entailment output can be used to train or otherwise improve the generative model.

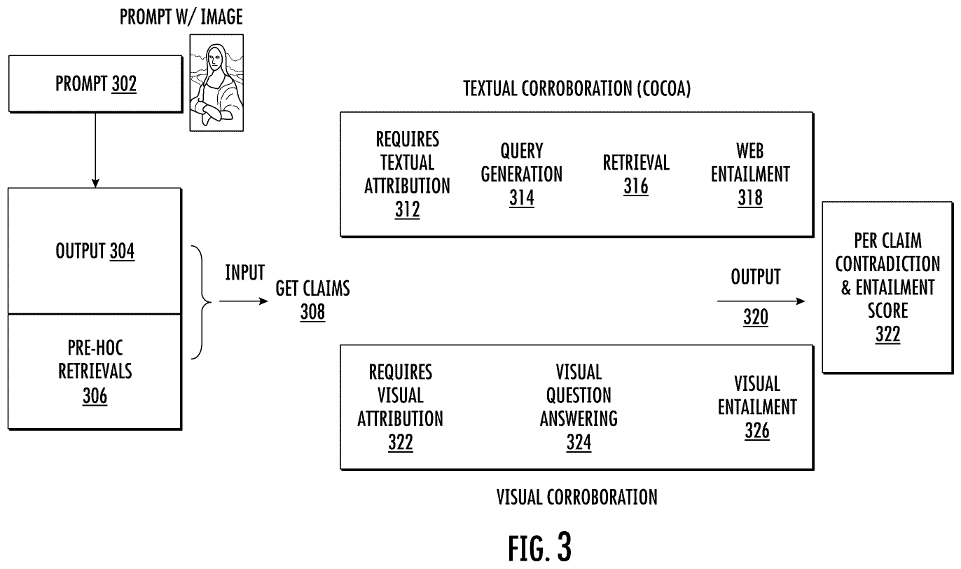

FIG. 3 depicts an example flow 300 for evaluating the output of a generative model in accordance with example embodiments of the present disclosure. In this example, the sequence processing model can receive a prompt 302. The prompt 302 can be submitted or selected from a database of training data. In this example, the prompt 302 includes an image.

The generative model can generate model output 304 based on the prompt 302. In some examples, the model output 304 can include one or more of: textual content, image content, video content, or other media content. In some examples, the output can be multimodal, such that it has two different types of content. Once the output 304 has been received, an evaluation system can access additional information as part of a pre-hoc retrieval 306. The data retrieved as part of a pre-hoc retrieval 306 can include information relevant to evaluating the model output 304 and determining whether it meets one or more quality standards. One or more quality standards can be associated with a determination whether the model output 304 is accurate with respect to either prompt 302 or respect to other portions of output 304.

In some examples, a representation extraction machine-learned model can receive the model output 304 and any information retrieved as part of a pre-hoc retrieval 306 as input. In some examples, the representation extraction machine-learned model can produce, as output, one or more representative subsequences (or claims 308) that correspond to a representation present in the output 304. In some examples, a request extraction machine-learned model can extract requests from the prompt 302.

Once one or more representative subsequences that correspond to a representation have been identified, the evaluation system can determine whether the representative subsequences that correspond to a representation are of high quality. Determining whether each representative subsequence that corresponds to a representation has high quality can involve a multi-step process. The first step can be determining, at 312, whether the representative subsequence that corresponds to a representation requires textual attribution. A representative subsequence that corresponds to a representation can be determined to need textual attribution if that representative subsequence that corresponds to a representation can be determined to be accurate based on information available in a database or available through a search query.

For example, a required attribution model can be trained to take a representative subsequence that corresponds to a representation as input and output a score for the representative subsequence that corresponds to a representation. The score can represent the degree to which a particular representative subsequence that corresponds to a representation can be determined to be accurate based on information available over the web. If the score exceeds the threshold, the representative subsequence that corresponds to a representation can be determined to require textual attribution. If not, the representative subsequence that corresponds to a representation can be determined not to require textual attribution.

Once a representative subsequence that corresponds to a representation is determined to require textual attribution, a textual corroboration system can, at 314, generate a query that can retrieve information useful in determining whether the representative subsequence that corresponds to a representation is accurate. The textual corroboration systems can, at 316, retrieve that data based on the query and, at 318, perform web entailment. The textual corroboration system can input the representative subsequence that corresponds to a representation and retrieved data into the natural language inference model as part of a web entailment process at 318. The natural language inference model can output an entailment score. If the entailment score generated by the natural language inference model exceeds a predetermined threshold, the representative subsequence that corresponds to a representation can be determined to have high quality. Similarly, if the entailment score is below the threshold, the representative subsequence that corresponds to a representation can be determined to have low quality (e.g., with respect to accuracy or other measures of quality).

The evaluation system can also determine, at 322, for each representative subsequence that corresponds to a representation, whether visual attribution is required. A representative subsequence that corresponds to a representation is determined to require visual attribution if it is relevant to a particular media element. The media element could be included in the prompt 302 or the output 304. A relevance determination model can input tuple pairs of a representative subsequence that corresponds to a representation and a media element. The relevance determination system can then determine whether each representative subsequence that corresponds to a representation is relevant to the media element included in the tuple pair.

In some examples, if the relevance determination model generates a relevancy score for a particular tuple pair that exceeds the predetermined threshold, the representative subsequence that corresponds to a representation can be determined to require visual attribution with respect to the particular element in the tuple pair. If the relevancy score does not satisfy the entailment threshold score, the representative subsequence that corresponds to a representation is determined not to need the required visual attribution concerning that media element.

The list of representative subsequences that correspond to a representation in the visual corroboration system can generate a list of relevant tuple pairs. The visual corroboration system can perform a visual question-answering process at 324. The visual corroboration can generate one or more questions about images or other media elements that are relevant to evaluating a particular representative subsequence that corresponds to a representation. A visual question-answering model can then be used to determine the answer for each determined visual question. The answers to the visual questions and a tuple pair can be provided, at 326, to the visual natural language inference model. The visual natural language inference model can generate an entailment score that represents the quality of a particular representative subsequence that corresponds to a representation to the media element included in its tuple pair. If the entailment score exceeds a threshold, the visual representative subsequence that corresponds to a representation regarding the associated media element can be determined to have high quality. If the score is below an entailment threshold score, the representative subsequence that corresponds to a representation can be determined to have low quality with respect to the associated media element.

In some examples, the evaluation system can access the entailment scores for all representative subsequences that correspond to a representation that require textual attribution and all representative subsequences that correspond to a representation that require visual attribution. The evaluation system can generate output 320 (e.g., entailment data) for representative subsequences that correspond to a representation requiring textual or visual attribution. The entailment data can represent whether all relevant representative subsequences that correspond to a representation (e.g., representative subsequences that correspond to a representation requiring textual attribution or visual attribution) are accurate. If one or more representative subsequences that correspond to a representation are determined to be inaccurate, the model output 304 can be determined to fail one or more quality standards.

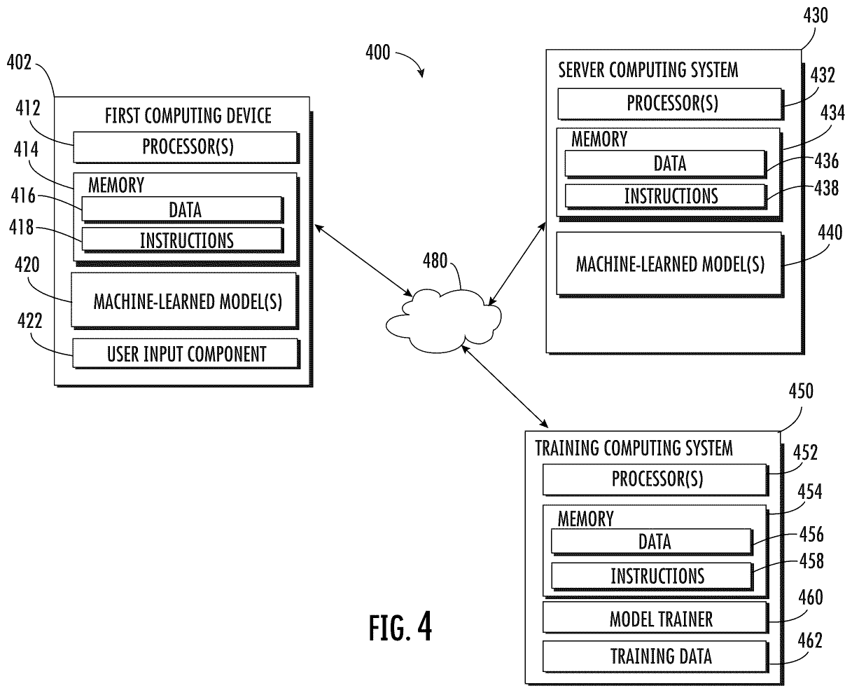

FIG. 4 depicts a block diagram of an example computing system 400 for automatically evaluating the output of machine-learned models for quality according to example embodiments of the present disclosure. The computing system 400 includes a first computing device 402, a server computing system 430, and a training computing system 450 that are communicatively coupled over a network 480.

The first computing device 402 can be any type of computing device, such as a personal computing device (e.g., laptop or desktop), a mobile computing device (e.g., smartphone or tablet), a gaming console or controller, a wearable computing device, an embedded computing device, or any other type of computing device.

The first computing device 402 includes one or more processors 412 and a memory 414. The one or more processors 412 can be any suitable processing device (e.g., a processor core, a microprocessor, an ASIC, an FPGA, a controller, a microcontroller, etc.) and can be one processor or a plurality of processors that are operatively connected. The memory 414 can include one or more non-transitory computer-readable storage mediums, such as RAM, ROM, EEPROM, EPROM, flash memory devices, magnetic disks, etc., and combinations thereof. The memory 414 can store data 416 and instructions 418, which are executed by the processor 412 to cause the first computing device 402 to perform operations.

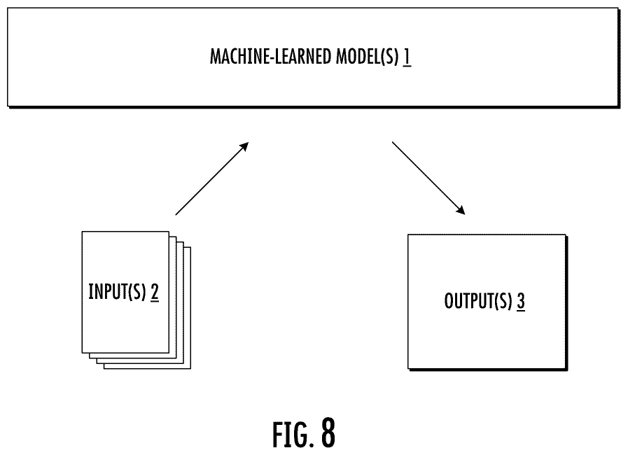

In some implementations, the first computing device 402 can store or include one or more machine-learned models 420 (e.g., a generative model and/or an evaluation system). For example, the machine-learned models 420 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 420 are discussed with reference to FIGS. 8-12.

In some implementations, the one or more machine-learned models 420 can be received from a server computing system 430 over network 480, stored in the memory 414 of the first computing device 402, and then used or otherwise implemented by the one or more processors 412. In some implementations, the first computing device 402 can implement multiple parallel instances of a single machine-learned model 420.

More particularly, the machine-learned model 420 (e.g., a generative model, a representation extraction machine-learned model, an entailment-scoring machine-learned model, a relevance scoring machine-learned model, a required attribute machine-learned model, a natural language inference model, a sequence processing model, and so on) can receive an input query. The input query can include a natural language request. In some examples, the input query can also include one or more media elements. Media elements can include image content, video content, audio content, or interactive content. In some examples, the generative model (e.g., a sequence processing model or other machine-learned model) can produce a model output. The model output can include textual content. The model output can also include one or more media elements. In some examples, the model output can be multimodal and include two or more types of content (e.g., textual and one or more types of media elements or two or more types of media elements).

In some examples, once the model output has been produced, an evaluation system can evaluate the output for quality to determine whether it meets one or more quality standards. This evaluation can occur automatically and provide information for training or evaluating machine-learned models. The evaluation system can process the model output to identify one or more representative subsequences that correspond to a representation. To do so, the evaluation system can use a representation extraction machine-learned model. In some examples, the representation extraction machine-learned model can be a machine-learned model trained to take portions of textual content as input and output one or more representative subsequences that correspond to a representation found within the textual content. Thus, the evaluation system can divide the textual content in the model output into one or more portions of text (e.g., spans). Each portion of text can be a group of words up to the length of a sentence.

The representation extraction machine-learned model can receive each portion of text as input and output one or more representative subsequences that correspond to a representation identified within the portion of text. A representative subsequence that corresponds to a representation is a representative subsequence that corresponds to a representation that can be evaluated for quality. In some examples, representative subsequences that correspond to a representation can be associated with general content and may be verifiable using general knowledge available on the web or from another location of data. In another example, representative subsequences that correspond to a representation can be relevant to a particular media element received in the input query or output by the generative model.

As such, the evaluation system can determine, for each representative subsequence that corresponds to a representation, whether the representative subsequence that corresponds to a representation needs to be evaluated for equality. The evaluation system can use a relevance determination machine-learned model to determine whether a particular representative subsequence that corresponds to a representation needs to be evaluated and, if so, whether it is relevant to a particular media element. The evaluation system can create a plurality of tuple pairs, each tuple pair including a representative subsequence that corresponds to a representation and a particular media element in the input query or the model output. In this way, each representative subsequence that corresponds to a representation can be compared against each media element. The total number of tuple pairs can be equal to the number of representative subsequences that correspond to a representation multiplied by the number of media elements in the input query and/or the model output. The evaluation system can provide each tuple pair as input to a relevance determination machine-learned model. A relevance determination machine-learned model can be an MM-RAD.

The relevance determination machine-learned model can take a tuple pair as input (including a representative subsequence that corresponds to a representation and a media element) and output a relevance score. The relevance score can represent the degree to which the representative subsequence that corresponds to a representation in the tuple pair is relevant to the media element in the tuple pair. The relevance score can be associated with the tuple pair. For example, the relevance score can be stored with the tuple pair for later retrieval.

In some examples, the relevance score for a particular tuple pair can be evaluated against a threshold relevance score. A threshold relevance score can represent a predetermined relevance score that is the threshold between relevant and irrelevant representative subsequences that correspond to a representation. Thus, any tuple pair that has an assigned relevant score that exceeds the threshold relevance score can be determined to include a relevant representative subsequence that corresponds to a representation. Tuple pairs with a relevance score below the threshold relevance score can be determined to include a representative subsequence that corresponds to a representation that it is not relevant. The evaluation system can generate a list of tuple pairs with relevant representative subsequences that correspond to a representation.

In some examples, the evaluation system can provide a list of tuple pairs that include relevant representative subsequences that correspond to a representation to an entailment-scoring machine-learned model. The entailment scoring model can be a visual natural language inference model that can take a tuple pair as input and determine the quality of the representative subsequence that corresponds to a representation in the tuple pair with respect to the media element in the tuple pair. In this way, the entailment-scoring model can generate an entailment score for each tuple pair. The entailment score can represent the degree to which a representative subsequence that corresponds to a representation in the tuple pair is determined to be accurate with respect to the media element in the tuple pair.

Once each tuple pair that includes a relevant representative subsequence that corresponds to a representation has received an entailment score, the evaluation system can determine whether the representative subsequences that correspond to a representation are high quality based on their entailment score. Representative subsequences that correspond to a representation with entailment score above a predetermined threshold entailment score can be determined to be high quality. Representative subsequences that correspond to a representation with an entailment score below the predetermined threshold entailment score can be determined to be of low quality.

In some examples, each representative subsequence that corresponds to a representation can also be evaluated to determine whether it can be validated based on information available via a web search or other means of retrieving information. Each representative subsequence that corresponds to a representation in the generated list can be provided to a web attribution required attribution detector model. The web attribution required attribution detector model can take a representative subsequence that corresponds to a representation as input and can output a web relevance score that indicates whether the representative subsequence that corresponds to a representation can be validated from a web search. For example, some representative subsequences that correspond to a representation may be relevant to particular media elements provided as input or generated as output and, therefore, may not be validated via a web search. However, other representative subsequences that correspond to a representation may be directed towards general knowledge or validated based on information available via a web search. As such, the web attribution required attribution detector model can generate a web relevance score representing whether the specific representative subsequence that corresponds to a representation can be validated using the web search.

In some examples, if the web attribution RAD model determines that a representative subsequence that corresponds to a representation is relevant to a web search, the evaluation system can add it to a list of relevant representative subsequences that correspond to a representation. The list of relevant representative subsequences that correspond to a representation can be provided to a natural language inference model associated with web retrieval. The evaluation system can determine whether a particular representative subsequence that corresponds to a representation is high quality based on a generated entailment score. The entailment score can be determined based at least in part on information received from a web search. In some examples, the evaluation system can generate relevant web queries and retrieve data to evaluate the relevant representative subsequences that correspond to a representation.

Each representative subsequence that corresponds to a representation can be given an entailment score, and the entailment score can be checked against a predetermined threshold entailment score. If the entailment score exceeds the threshold entailment score, the representative subsequence that corresponds to a representation can be determined to be high quality and representative subsequences that correspond to a representation with entailment scores that do not exceed the threshold entailment score can be determined to be low quality.

The evaluation system can generate entailment output for the model output based on the entailment scores for representative subsequences that correspond to a representation associated with media elements and representative subsequences that correspond to a representation associated with web search data. The entailment output can include an indication of whether the output of the generative model meets one or more quality standards. For example, if all relevant representative subsequences that correspond to a representation have been determined to be high quality (e.g., with respect to accuracy or other measures of quality), the entailment output can indicate that the output meets one or more quality standards. However, suppose one or more relevant representative subsequences that correspond to a representation are determined to be of low quality. In that case, the entailment output can include information indicating that the model output does not meet one or more quality standards. The entailment output may also include the specific representative subsequences that correspond to a representation made that were determined to be low quality (e.g., lack of accuracy or other quality measures). The entailment output can be used for training or otherwise providing feedback to the generative model, flagging inappropriate output, or identifying output that needs to be regenerated.

In another example use, the evaluation system can determine whether an output meets one or more requests included in the input. For example, if the input includes textual content, the evaluation system can divide the textual content into one or more portions of text (e.g., spans). A request-extraction machine-learned model can analyze each portion of text to identify one or more requests in the textual content. For example, if the textual content requests that an image be generated that includes a cat wearing a party hat, the request extraction model may determine that the requests include “the image includes a cat” and “the cat in the image is wearing a party hat.”

The evaluation system can access the output by the generative model. The output can include textual content. The output can also include one or more media elements. In some examples, the output can be multimodal and include textual content, one or more media elements, or two or more types of media elements.

As mentioned above, the evaluation system can use one or more relevance-determination machine-learned models to determine whether the requests in the input query have been satisfied by the output. As described above, an MM-RAD model can be used. To do so, the evaluation system can generate a plurality of tuple pairs, each tuple pair including a request and a media element. The MM-RAD model can generate a relevance score for each tuple pair. The relevance score can represent whether the request in the tuple pair is relevant to the media element in the tuple pair. All tuple pairs determined to include a relevant request can be grouped into a list of relevant tuple pairs.

Each tuple pair in the list of relevant tuple pairs can be provided to an entailment scoring model. The entailment scoring model can generate an entailment score for each tuple pair. Each entailment score can represent the degree to which the request is satisfied by the media element in the tuple pair. Tuple pairs with an entailment score above the threshold are determined to satisfy the request, and tuple pairs with entailment scores below the threshold are determined not to satisfy the request.

In some examples, the evaluation system can generate an entailment output. The entailment output can include determining whether the output satisfies all relevant requests in the input query. If one or more requests do not satisfy the output, the output can be determined to fail to meet one or more quality standards. However, if all requests are adequately satisfied by the output, the output can be defined to satisfy the quality standards adequately.

The first computing device 402 can also include one or more user input components 422 that receives user input. For example, the user input component 422 can be a touch-sensitive component (e.g., a touch-sensitive display screen or a touchpad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage mediums, such as RAM, ROM, EEPROM, EPROM, flash memory devices, magnetic disks, etc., and combinations thereof. The memory 434 can store data 436 and instructions 438 which are executed by the processor 432 to cause the server computing system 430 to perform operations.

In some implementations, the server computing system 430 includes or is otherwise implemented by one or more server computing devices. In instances in which server computing system 430 includes plural server computing devices, such server computing devices can operate according to sequential computing architectures, parallel computing architectures, or some combination thereof.

As described above, the server computing system 430 can store or otherwise include one or more machine-learned models 440 (e.g., a generative model or machine-learned models used by an evaluation system). For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 440 are discussed with reference to FIGS. 8-12.

The first computing device 402 and/or a server computing system 430 can train the models 420 and/or 440 via interaction with the training computing system 450, which is communicatively coupled over the network 480. The training computing system 450 can be separate from or a portion of the server computing system.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage mediums, such as RAM, ROM, EEPROM, EPROM, flash memory devices, magnetic disks, etc., and combinations thereof. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that trains the machine-learned models 420 and/or 440 stored at the first computing device 402 and/or the server computing system 430 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 460 can perform a number of generalization techniques (e.g., weight decays, dropouts, etc.) to improve the generalization capability of the models being trained.

In particular, the model trainer 460 can train the image generation system and the classifiers based on a set of training data 462. The training data 462 can include, for example, example ratings of various types of outcomes for an iterative narrowing process, user preference data, schedule data, and so on. In some examples, the model trainer 460 can use entailment output (or other feedback) from an evaluation system (e.g., evaluation system 120 in FIG. 1).

The model trainer 460 includes computer logic utilized to provide desired functionality. The model trainer 460 can be implemented in hardware, firmware, and/or software controlling a general-purpose processor. For example, in some implementations, the model trainer 460 includes program files stored on a storage device, loaded into a memory and executed by one or more processors. In other implementations, the model trainer 460 includes one or more sets of computer-executable instructions that are stored in a tangible computer-readable storage medium such as RAM, hard disk, or optical/magnetic media.

The network 480 can be any type of communications network, such as a local area network (e.g., intranet), wide area network (e.g., Internet), or some combination thereof and can include any number of wired or wireless links. In general, communication over the network 480 can be carried via any wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can include image data. The machine-learned model(s) can process the image data to generate an output based on a request. As an example, the machine-learned model(s) can process the image data to generate a new image by extracting information from the image data and updating or modifying it based on the request.

In some implementations, the input to the machine-learned model(s) of the present disclosure can be text or natural language data. The machine-learned model(s) can process the text or natural language data to generate an output. As an example, the machine-learned model(s) can process the natural language data to a particular image request and generate a prompt based on the image request.

In some implementations, the input to the machine-learned model(s) of the present disclosure can be speech data. The machine-learned model(s) can process the speech data to generate an output. As an example, the machine-learned model(s) can process the speech data to generate a speech recognition output. The output of the speech recognition system can be used as input to the image generation model.

FIG. 4 illustrates one example computing system that can be used to implement the present disclosure. Other computing systems can be used as well. For example, in some implementations, the first computing device 402 can include the model trainer 460 and the training dataset 462. In such implementations, the model(s) 420 can be trained and used locally at the first computing device 402. In some implementations, the first computing device 402 can implement the model trainer 460 to personalize the models 420 based on user-specific data.

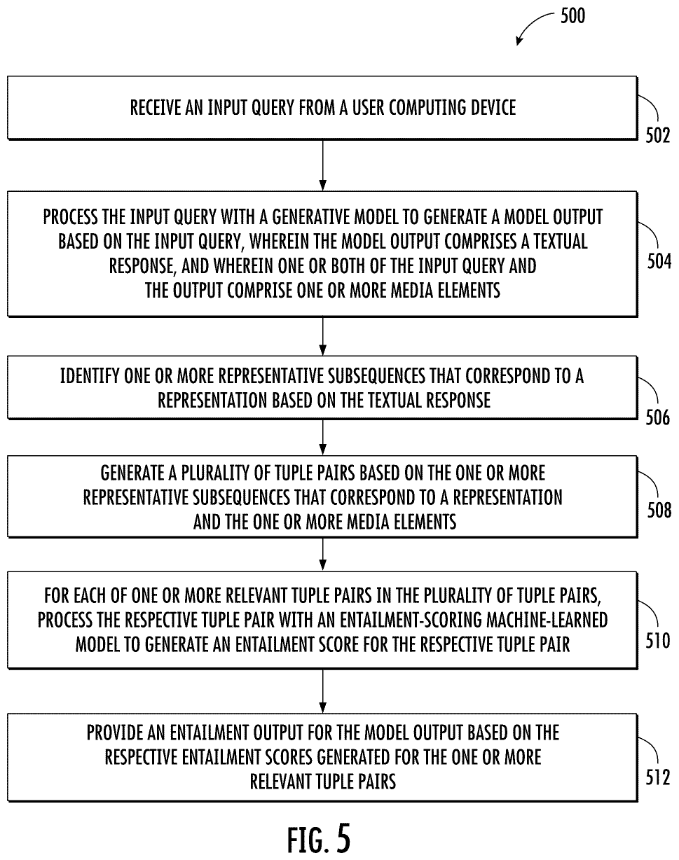

FIG. 5 is a flow diagram representing a process 500 for automatically evaluating the output of a generative model in accordance with example embodiments of the present disclosure. A computing system with one or more processors can perform a method. The method can include, at 502, receiving an input query. In some examples, the input query can be multimodal and can include at least one of the one or more media elements.

The method can include, at 504, processing the input query with a generative model to generate a model output based on the input query, wherein the model output comprises a textual response, and wherein one or both of the input query and the output comprise one or more media elements. The generative model can be a sequence processing model. The media elements can comprise one or more of video content, image content, audio content, and interactive content. In some examples, the textual response includes a plurality of portions of text.

In some examples, the evaluation system can generate a prompt as input for the generative model based on the input query. The prompt can comprise a natural language explanation of the input query. The computing system can, at 506, identify one or more representative subsequences that correspond to a representation based on the textual response. Identifying one or more representative subsequences that correspond to a representation based on the textual response further comprises providing a respective span in the plurality of portions of text to a representation detection machine-learned model. The evaluation system can receive an output from the representation detection machine-learned model, wherein the output includes one or more representative subsequences that correspond to a representation from the respective span.

In some examples, the evaluation system can, at 508, generate a plurality of tuple pairs based on the one or more representative subsequences that correspond to a representation and the one or more media elements. Each tuple pair can include a representative subsequence that corresponds to a representation from the one or more representative subsequences that correspond to a representation and one media element from the one or more media elements. In some examples, the evaluation can identify relevant tuple pairs. To do so, the evaluation system can process the respective tuple pair with a relevance-scoring machine-learned model to generate a relevance score for the respective tuple pair. In some examples, the evaluation system can generate a list of relevant tuple pairs based on the relevance score for each tuple pair;

In some examples, the evaluation can generate a list of relevant tuple pairs based on the relevance score for each tuple pair by, for each respective tuple pair in the list of tuple pairs, determining that the relevance score for the respective tuple pair satisfies a relevance threshold score. In accordance with a determination that the relevance score for the respective tuple pair satisfies the relevance threshold score, the evaluation system can add the respective tuple pair to the list of relevant tuple pairs.

In some examples, the relevance score for the respective tuple pair can represent a degree to which the representative subsequence that corresponds to a representation included in the respective tuple pair is relevant to the media element included in the tuple pair. The number of tuple pairs in the plurality of tuple pairs are based on a number of representative subsequences that correspond to a representation in the one or more representative subsequences that correspond to a representation and a number of media elements in the one or more media elements.

For each of one or more relevant tuple pairs in the plurality of tuple pairs, the evaluation system can, at 510, process the respective tuple pair with an entailment-scoring machine-learned model to generate an entailment score for the respective tuple pair. The relevance-scoring machine-learned model can be a required attribution model trained to generate a relevance score for a particular tuple pair that represents a degree to which a representative subsequence that corresponds to a representation included in the respective tuple pair is relevant to the media element included in the respective tuple pair.

The evaluation system can, for each respective representative subsequence that corresponds to a representation in the one or more representative subsequences that correspond to a representation, execute a web-based required attribution detector model trained to determine whether the respective representative subsequence that corresponds to a representation can be validated based on information available through a web search. In response to a determination that the respective representative subsequence that corresponds to a representation can be validated based on information available through a web search, the evaluation system can execute a web-based natural language inference model with web retrieval to determine a web entailment score for the respective representative subsequence that corresponds to a representation.

In some examples, the evaluation system can, at 512, provide an entailment output for the model output based on the respective entailment scores generated for the one or more relevant tuple pairs. Providing the entailment output for the model output can comprise determining, by the evaluation system, that the entailment score for all the relevant tuple pairs in the list of relevant tuple pairs satisfies an entailment threshold score. In accordance with a determination that the entailment score for all the relevant tuple pairs have associated entailment scores that satisfy the entailment threshold score, the evaluation system can determine that the output meets a quality measure for generated output.

The evaluation system can, in accordance with a determination that at least one respective in the list of relevant tuple pairs has an associated entailment score that does not satisfy the entailment threshold score, determine that the output does not meet a quality measure for generated output. In some examples, the entailment-scoring machine-learned model is a VNLI model. Additionally or alternatively, the entailment-scoring machine-learned model is a natural language inference model (without the visual component).

The evaluation system can transmit the entailment output to the user computing device for display. In some examples, the evaluation system can be used to generate feedback for a training process. In other examples, the evaluation system can be used to screen the output of a generative model to identify output that does not meet quality standards. In this case, the evaluation system can, in accordance with a determination that at least one relevant tuple pair in the list of relevant tuple pairs has an associated entailment score that does not satisfy the entailment threshold score, generate an updated prompt, the updated prompt including information describing at least one tuple pair with an entailment score that does not satisfy the entailment threshold score. The generative model can provide the updated prompt to a generative model to produce an updated output. The updated prompt can include information from the original prompt (including the input query) and information about the specific representative subsequence that corresponds to a representation that was determined to be low quality (e.g., not accurate).

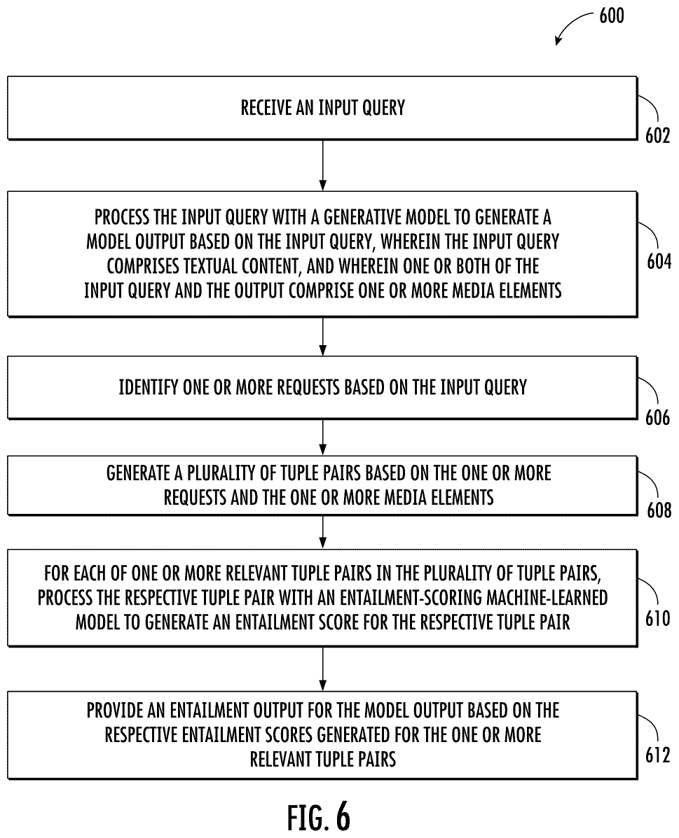

FIG. 6 is a flow diagram representing a process 600 for automatically evaluating the output of a generative model in accordance with example embodiments of the present disclosure. The process can be performed by a computing system. The computing system can comprise one or more processors and one or more non-transitory computer-readable media that store instructions. In some examples, the computing system can, at 602, receive an input query. The computing system can, at 604, process the input query with a generative model to generate a model output based on the input query, wherein the input query comprises textual content, and wherein one or both of the input query and the output comprise one or more media elements.

The computing system can include an evaluation system that can be used to determine whether the output meets one or more quality standards. In some examples, the evaluation system can, at 606, identify one or more requests based on the input query. The evaluation system can generate, at 608, a plurality of tuple pairs based on the one or more representative subsequences that correspond to a representation and the one or more media elements. For each of one or more relevant tuple pairs in the plurality of tuple pairs, the evaluation system can, at 610, process the respective tuple pair with an entailment-scoring machine-learned model to generate an entailment score for the respective tuple pair.

The evaluation system can, at 612, provide an entailment output for the model output based on the respective entailment scores generated for the one or more relevant tuple pairs.

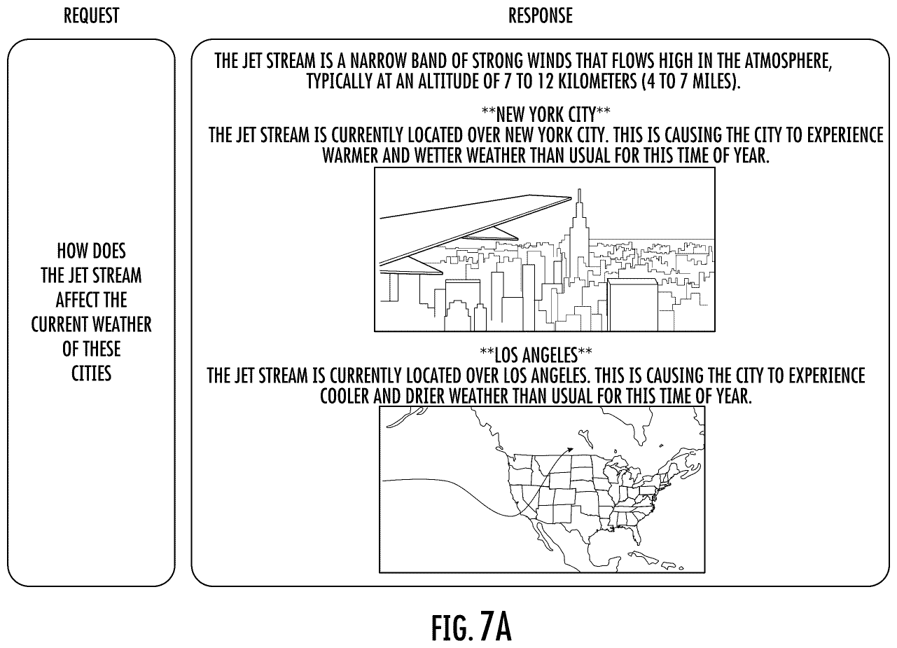

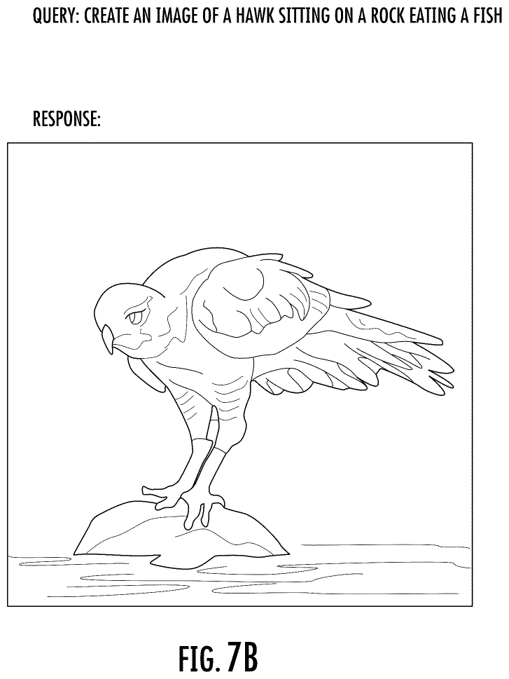

FIG. 7A is an example input query and model output in accordance with example embodiments of the present disclosure. In this example, the input query includes a request. The request reads “how does the jet stream affect the current weather of these cities.” The output includes both textual content and image content. In this example, a portion of the text is highlighted and one of the images is highlighted. In some examples, the evaluation system can determine that the highlighted portion of text may be relevant to the highlighted image. The evaluation system can determine whether the highlighted portion of text includes a representative subsequence that corresponds to a representation that can be evaluated against the image.

FIG. 7B is an example input query and model output in accordance with example embodiments of the present disclosure. In this example, the input query includes a request. The request reads “create an image of a hawk sitting on a rock eating a fish.” The evaluation system can evaluate the text of the input to determine one or more requests. In this example, the request may include “the image includes a hawk,” “the hawk in the image is sitting on a rock,” and “the hawk in the image is eating a fish.”

The evaluation system can compare each request to the media element to determine whether the requests are relevant to the media element. If relevant, the evaluation system can determine whether each request is fulfilled by the image. In this example, the hawk does not appear to be eating the fish, so at least one of the requests is determined to be unfulfilled. As a result, an entailment output by the evaluation system may determine that the output does not meet one or more quality standards.

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of a message generation model. Although various features, variations, and implementations described below are described with respect to machine-learned model(s) 1, it is to be understood that such features, variations, and implementations are to be understood as described with respect to the message generation model, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

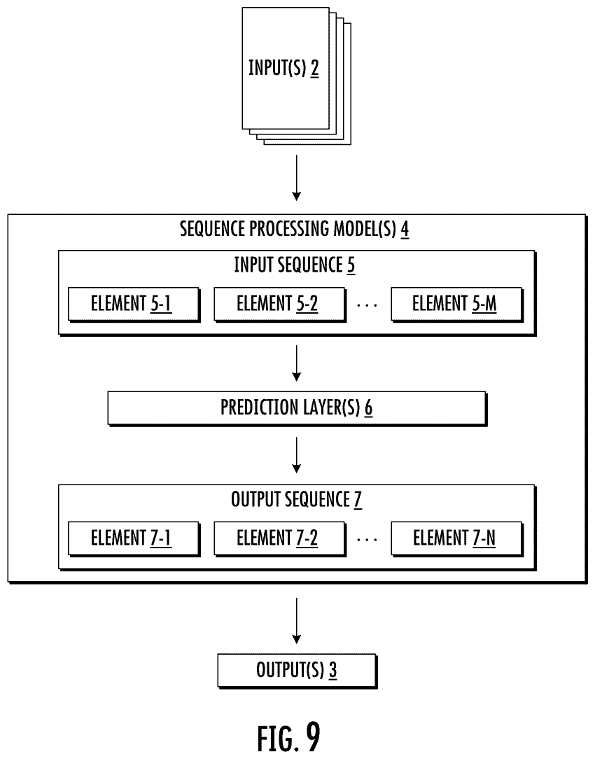

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 9 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

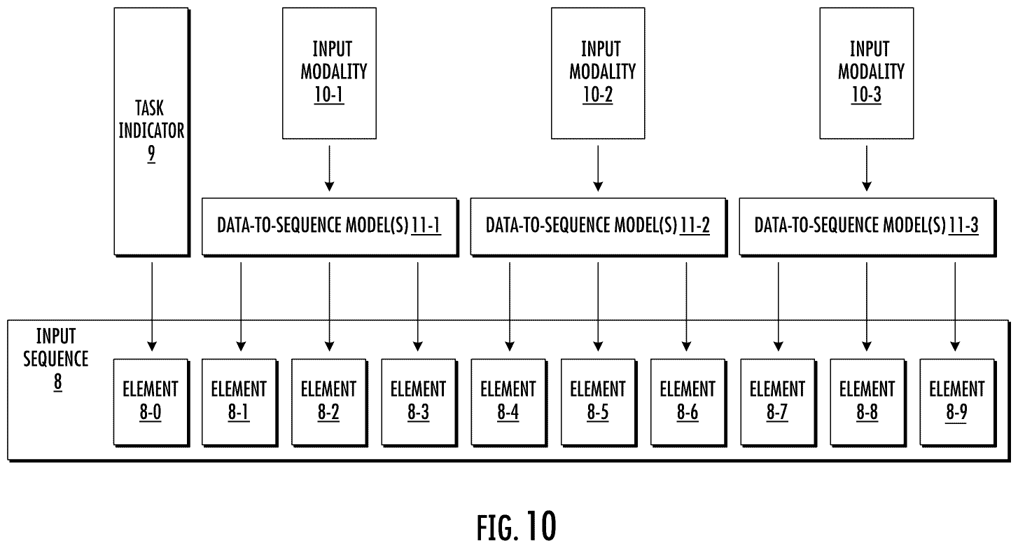

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

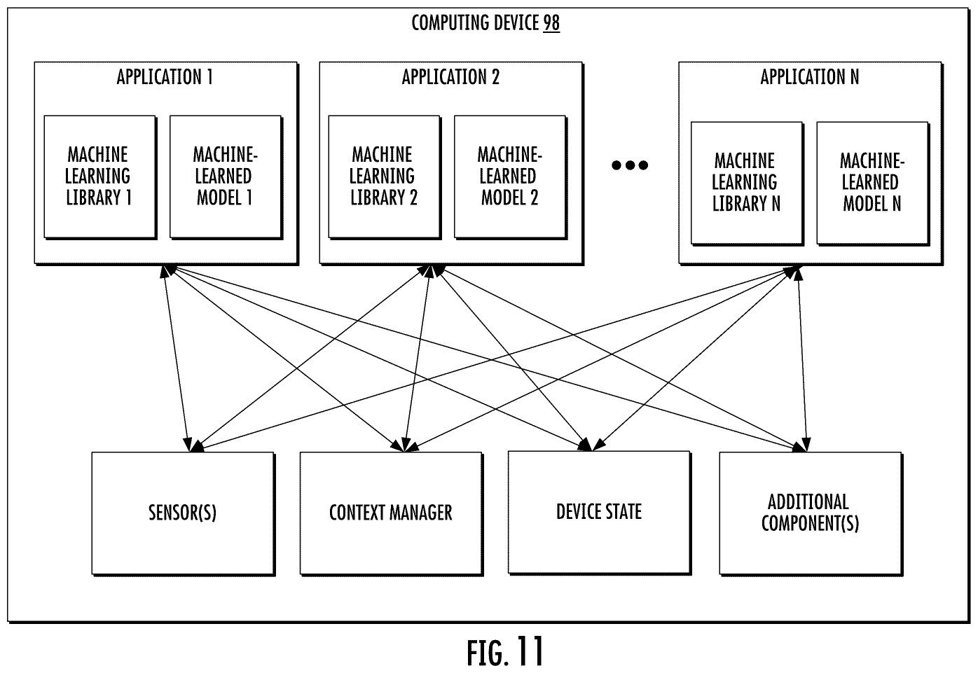

FIG. 11 is a block diagram of an example computing device 98 that performs according to example embodiments of the present disclosure. Computing device 98 can be a user computing device or a server computing device (e.g., computing device 50, server computing system(s) 60, etc.). Computing device 98 can implement a model host. For instance, computing device 98 can include a number of applications (e.g., applications 1 through N). Each application can contain its own machine-learned library and machine-learned model(s). For example, each application can include a machine-learned model. Example applications include a text messaging application, an email application, a dictation application, a virtual keyboard application, a browser application, etc. As illustrated in FIG. 11, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

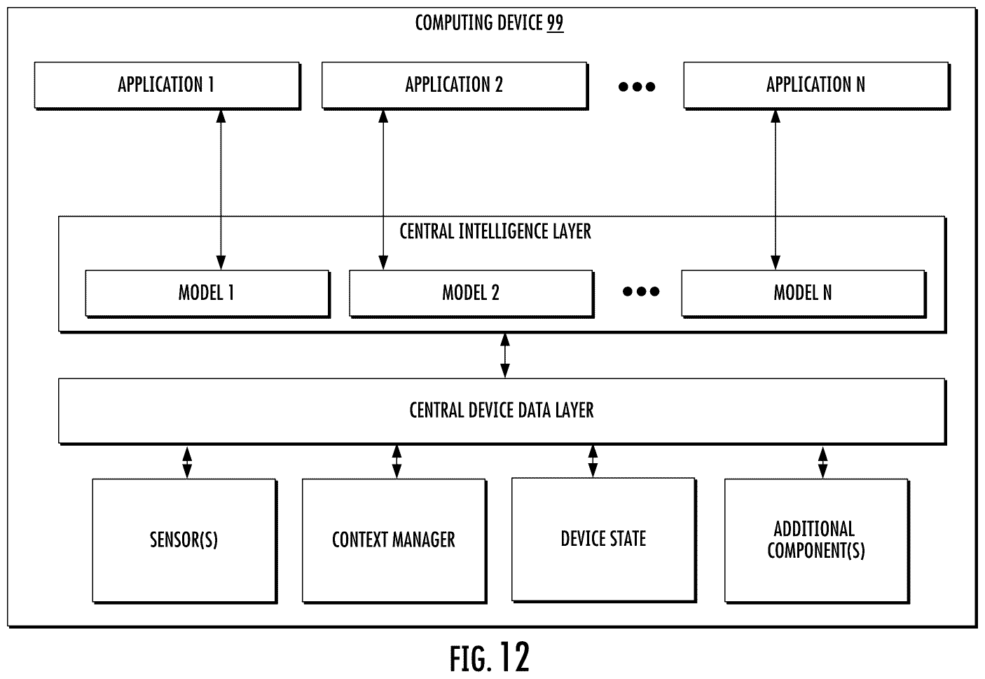

FIG. 12 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 12, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 11, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for automatically evaluating a model output, the method comprising:
receiving, by a computing system with one or more processors, an input query;
processing, by the computing system, the input query with a generative model to generate a model output based on the input query, wherein the model output comprises a textual response, and wherein one or both of the input query and the output comprise one or more media elements;
identifying, by the computing system, one or more representative subsequences that correspond to a representation based on the textual response;
generating, by the computing system, a plurality of tuple pairs based on the one or more representative subsequences that correspond to a representation and the one or more media elements;
for each of one or more relevant tuple pairs in the plurality of tuple pairs, processing, by the computing system, the respective tuple pair with an entailment-scoring machine-learned model to generate an entailment score for the respective tuple pair; and
providing, by the computing system, an entailment output for the model output based on the respective entailment scores generated for the one or more relevant tuple pairs.

2. The computer-implemented method of claim 1, wherein the method further comprises identifying the one or more relevant tuple pairs, wherein identifying the one or more relevant tuple pairs comprises:
processing, by the computing system, the respective tuple pair with a relevance-scoring machine-learned model to generate a relevance score for the respective tuple pair; and
generating, by the computing system, a list of relevant tuple pairs based on the relevance score for each tuple pair.

3. The computer-implemented method of claim 2, wherein generating, by the computing system, the list of relevant tuple pairs based on the relevance score for each tuple pair further comprises:
for each respective tuple pair in the list of tuple pairs:
determining, by the computing system, that the relevance score for the respective tuple pair satisfies a relevance threshold score; and
in accordance with a determination that the relevance score for the respective tuple pair satisfies the relevance threshold score, adding, by the computing system, to the list of relevant tuple pairs.

4. The computer-implemented method of claim 2, wherein each tuple pair includes a representative subsequence that corresponds to a representation from the one or more representative subsequences that correspond to a representation and one media element from the one or more media elements.

5. The computer-implemented method of claim 4, wherein the relevance score for the respective tuple pair represents a degree to which the representative subsequence that corresponds to a representation included in the respective tuple pair is relevant to the media element included in the tuple pair.

6. The computer-implemented method of claim 2, wherein the relevance-scoring machine-learned model is a multimodal required attribution detector model trained to generate a relevance score for a particular tuple pair that represents a degree to which a representative subsequence that corresponds to a representation included in the respective tuple pair is relevant to a media element included in the respective tuple pair.

7. The computer-implemented method of claim 2, wherein providing, by the computing system, the entailment output for the model output comprises:
determining, by the computing system, that the entailment score for all the relevant tuple pairs in the list of relevant tuple pairs satisfy an entailment threshold score; and
in accordance with a determination that the entailment score for all the relevant tuple pairs have associated entailment scores that satisfies the entailment threshold score, determining, by the computing system, that the output meets a quality measure for generated output.

8. The computer-implemented method of claim 7, the method further comprising:
in accordance with a determination that at least one respective tuple pair in the list of relevant tuple pairs has an associated entailment score that does not satisfy the entailment threshold score, determining, by the computing system, that the output does not meet a quality measure for generated output.

9. The computer-implemented method of claim 8, wherein the entailment-scoring machine-learned model is a visual natural language inference model.

10. The computer-implemented method of claim 1, the method further comprising:
transmitting, by the computing system, the entailment output to a user computing device for display.

11. The computer-implemented method of claim 1, wherein the one or more media elements comprise one or more of video content, image content, audio content, and interactive content.

12. The computer-implemented method of claim 1, wherein the input query is multimodal and includes at least one of the one or more media elements.

13. The computer-implemented method of claim 1, wherein the textual response includes a plurality of portions of text.

14. The computer-implemented method of claim 13, wherein identifying one or more representative subsequences that correspond to a representation based on the textual response further comprises:
providing, by the computing system, a respective span in the plurality of portions of text to a representation detection machine-learned model; and
receiving, by the computing system, an output from the representation detection machine-learned model, wherein the output includes one or more representative subsequences that correspond to a representation from the respective span.

15. The computer-implemented method of claim 1, wherein processing, by the computing system, the input query with the generative model to generate the model output based on the input query comprises:
generating, by the computing system, a prompt as input for the generative model based on the input query.

16. The computer-implemented method of claim 15 wherein the prompt includes a natural language explanation of the input query.

17. The computer-implemented method of claim 1, wherein a number of tuple pairs in the plurality of tuple pairs are based on a number of representative subsequences that correspond to a representation in the one or more representative subsequences that correspond to a representation and a number of media elements in the one or more media elements.

18. The computer-implemented method of claim 1, the method further comprising:
for each respective representative subsequence that corresponds to a representation in the one or more representative subsequences that correspond to a representation, executing, by the computing system, a web-based required attribution detector model trained to determine whether the respective representative subsequence that corresponds to a representation can be validated based on information available through a web search.

19. The computer-implemented method of claim 18, further comprising:
in response to a determination that the respective representative subsequence that corresponds to a representation can be validated based on information available through a web search, executing, by the computing system, a web-based natural language inference model with web retrieval to determine a web entailment score for the respective representative subsequence that corresponds to a representation.

20. A computing system, comprising:
one or more processors; and
one or more non-transitory computer-readable media that store instructions wherein, when executed by the one or more processors, the instructions cause the one or more processors to perform operations, the operations comprising:
receiving an input query;
processing the input query with a generative model to generate a model output based on the input query, wherein the input query comprises textual content, and wherein one or both of the input query and the output comprise one or more media elements;
identifying, by the computing system, one or more representative subsequences that correspond to a representation based on the textual response;
generating a plurality of tuple pairs based on the one or more representative subsequences that correspond to a representation and the one or more media elements;
for each of one or more relevant tuple pairs in the plurality of tuple pairs, processing the respective tuple pair with an entailment-scoring machine-learned model to generate an entailment score for the respective tuple pair; and
providing an entailment output for the model output based on the respective entailment scores generated for the one or more relevant tuple pairs.
